(19) United States
(12) Patent Application Publication
(10) Pub. No.: US 2024/0210277 A1
(43) Pub. Date: Jun. 27, 2024

(54) DEVICE AND METHOD FOR ESTIMATING AT LEAST ONE PROPERTY OF A ROTATING SYSTEM

(71) Applicant: Aktiebolaget SKF, Göteborg (SE)

(72) Inventor: Stijn VAN EESBEEK, Doorn (NL)

(21) Appl. No.: 18/534,016

(22) Filed: Dec. 8, 2023

(30) Foreign Application Priority Data
Dec. 21, 2022 (DE) 102022214213.6

(51) Int. Cl. G01M 13/04

(52) U.S. Cl. CPC G01M 13/04

(57) ABSTRACT

A device (18) is disclosed for estimating at least one property of a rotating system (1). The rotating system (1) includes at least one rotating component (2, 12). The device (18) includes at least one sensor probe (8) arranged at the at least one rotating component (2, 12). The at least one sensor probe (8) measures a displacement and/or strain of the at least one rotating component (2, 12). A receiving unit (20) receives a sensor signal waveform provided by the at least one sensor probe (8). An electronic control unit (22) processes the received measured sensor signal waveform. The electronic control unit (22) determines a spectrum of the load acting on the at least one rotating component from the measured sensor signal waveform, and estimates the at least one property of the rotating system (1) from the determined spectrum.

### CROSS-REFERENCE TO RELATED APPLICATION

This application claims priority to German Application No. 102022214213.6, filed Dec. 21, 2022, the entirety of which is hereby incorporated by reference.

### FIELD

The present disclosure relates to a device for estimating at least one property of a rotating system. Further, the present disclosure relates to a fluid machinery and a method for estimating at least one property of a rotating system.

### BACKGROUND

In most rotating systems, a rotation of a rotating component is supported by at least one bearing, while at least a part of the rotating component interacts with a fluid, such as air, water, oil, grease, and other liquid and/or gaseous mediums. Thus, a significant part of a load on a rotating system is due to a periodic transfer of force between the rotating component and the fluid. Moreover, a state of the fluid can have a significant effect on properties of the load. For example, a change in viscosity and/or density of the fluid can change qualitative and quantitative properties of the load acting on the rotating system.

The force transferred between the rotating component and the fluid can also lead to bending and/or displacement of the rotating component and can thereby be linked to an additional loading of components attached and/or connected to the rotating component, such as bearings, seals, couplings, etc. Thus, the load transferred between the fluid and the rotating system can also have an effect on a performance, wear, and life span of the components attached and/or connected to the rotating component and therefore on the entire rotating system.

However, in most cases the load acting on the various parts of the rotating system can only be determined indirectly. In order to increase a performance and/or life span of a rotating system and/or reduce wear on parts of the rotating system, it may be beneficial to estimate properties of the rotating system and/or the load acting on the various parts of the rotating system in more direct way and/or in way that is less sensitive to noise factors.

It is therefore object of the present disclosure to estimate at least one property of the rotating system in more direct way and/or in a way that is less sensitive to noise factors.

### SUMMARY

This object is solved by a device for estimating at least one property of a rotating system according to claim 1 and a method for estimating at least one property of a rotating system according to claim 10.

In the following, a device for estimating at least one property of a rotating system is provided, wherein the rotating system comprises at least one rotating component. The device comprises at least one sensor probe arranged at an element of the rotating system, wherein the at least one sensor probe is configured to measure a displacement and/or strain of the at least one rotating component. For example, at least one sensor probe may be configured to provide a sensor signal waveform, wherein the sensor signal waveform is a product of a carrier waveform and a load waveform. For example, the load waveform may be defined by at least one load frequency having an associated amplitude and a phase. The at least one rotating component may be a bearing ring, a rolling element, and/or a rotating shaft.

Preferably, the at least one sensor probe may be configured to measure a displacement and/or deformation of the at least one rotating component related to a periodic force acting on the at least one rotating component. For example, the at least one sensor probe may be a strain gauge, a fiber optic-based strain gauge, a piezo-resistive sensing element, an eddy current sensor measuring a displacement or any other sensor gauge capable of sensing a displacement and/or deformation of the element. Furthermore, a plurality of sensor probes may be arranged at the rotating system.

In addition, the device comprises a receiving unit for receiving a sensor signal waveform provided by the at least one sensor probe, and an electronic control unit configured for processing the received measured sensor signal waveform. Furthermore, the device may include a transmitting unit configured to transmit the sensor signal from the at least one sensor probe to the electronic control unit. In particular, the measured sensor signal may be transmitted to the electronic control unit via at least one cable and/or wireless.

In order to estimate at least one property of the rotating system in more direct way and/or in a way that is less sensitive to noise factors, the electronic control unit is further configured to determine a spectrum of the load acting on the at least one rotating component from the measured sensor signal waveform, and to estimate the at least one property of the rotating system from the determined spectrum. Preferably, the spectrum of the load acting on the at least one rotating component may be determined by determining a spectrum from the measured sensor signal waveform, i.e. determining a strain spectrum, or by determining a load waveform from the measured sensor signal waveform and subsequently determining a spectrum from the determined load waveform. More particularly, determining the spectrum may include a determination of qualitative and/or quantitative information of spectrum, such as an amplitude of a peak in the spectrum, a position of a peak, i.e. a frequency of the load, phase characteristics and/or frequency combinations of load. The information can be used to determine a working point of the rotating system.

Furthermore, the term “strain” refers to a local deformation of the material, more particularly a deformation of the material at the location of the sensor, wherein the strain is defined as e=ΔL/L, wherein ΔL is a change in length of a piece of material and L is the original length of the piece of material.

The term “load” refers to a force that acts on the element of the rotating system. In case that the sensor probe is arranged at a bearing ring, it may be necessary, depending on the location of the sensor probe, to reconstruct the bearing loads from the measured rolling element loads. For example, US 2021/0010883 A1 describes a method how at least one bearing load can be reconstructed from at least one measured rolling element load.

The electronic control unit may be configured to determine a rotation frequency from the measured senor signal waveform. The rotation frequency may be a frequency of the rotating component such as a rolling element frequency, or a shaft frequency. The term “rolling element frequency” refers to the frequency with which any rolling element passes the at least one sensor probe. The term “shaft frequency” refers to the frequency with the rotating shaft passes the at least one sensor probe.

Further, the electronic control unit may also be configured to determine the carrier waveform based on the determined rotation frequency and the measured sensor signal waveform. For example, determining the carrier waveform may comprise parameterizing the carrier waveform. The electronic control unit may also be configured to determine the load waveform based on the determined carrier waveform and the measured sensor signal waveform and to estimate the load in the rotating element from the determined load waveform. In particular, the electronic control unit may be configured to determine the carrier waveform and the load waveform simultaneously. Alternatively, the carrier waveform and the load waveform may be determined sequentially.

Moreover, the electronic control unit may also be configured to recalibrate the load waveform into a suitable unit of measurement such as the metric system. Determining both the load waveform and the carrier waveform allows to separate the load waveform from the carrier waveform which may allow to shift the limiting frequency for estimating loads to the rotation frequency or even above. In other words, loads having frequencies up to the rotation frequency or even above can be determined and evaluated. This allows for an estimation and evaluation of loads having a broad range of frequencies.

Preferably, the sensor signal waveform is provided in the time domain, and wherein the determining the spectrum includes transforming the measured sensor signal waveform from the time domain into the frequency domain, preferably by using a fast Fourier transformation. Transforming the measured sensor signal to the frequency domain allows for a simple and efficient determination of the rotation frequency of the rotating system and/or a frequency of the load and/or strain.

According to a further embodiment, the electronic control unit is configured to analyze the determined spectrum, wherein analyzing the determined spectrum includes determining a position and/or a magnitude of at least one peak in the determined spectrum and/or determining phase characteristic of the load and/or strain. More particularly, analyzing the spectrum may include a determination of qualitative and/or quantitative information of the spectrum, such as a phase characteristic of the load and/or strain, an amplitude or magnitude of a peak in the spectrum, a position of a peak, i.e. a frequency of the load and/or strain, and/or frequency combinations of load and/or strain. Moreover, the electronic control unit may be configured to also determine a peak width. The peak width may be a FWHM (full width at half maximum)-width. The information can be used to determine a working point of the rotating system.

Furthermore, the electronic control unit may be configured to determine a control signal for controlling the system based on the determined spectrum. For example, the control signal may be a signal that controls a drive frequency with which the rotating system is driven. For example, the control signal may be used to stay at the measured working point or to move away from the measured working point to reach a higher efficiency or prolonged lifetime.

Preferably, determining the control signal comprises comparing the determined spectrum to a reference spectrum and/or determining an absolute magnitude of at least one peak and/or determining a relative amplitude between a first peak and a second peak and/or determining a peak width and/or determining a phase characteristic of the load and/or determining a phase characteristic of the strain and/or comparing the absolute magnitude of at least one peak to a predefined threshold, and/or comparing the determined relative magnitude between at least two peaks to a predefined threshold.

According to a further preferred embodiment, the rotating system is a fluid machinery having a rotating shaft with at least one element configured to interact with a fluid, wherein the rotating shaft is supported by a bearing, and wherein the at least one sensor probe is arranged at the bearing and/or the rotating shaft. For example, the fluid machinery may be an agitator, a wind turbine, an underwater turbine, a marine propeller. The fluid machinery may include a rotating shaft. The element configured to interact with the fluid may be attached to the rotating shaft. Furthermore, the element configured to interact with the fluid may be a blade, a lobe, a propeller, a vane. In addition, a plurality of elements interacting with the fluid may be attached to the rotating shaft. For example, a propeller having a plurality of blades, e.g. two, three, four or more blades, may be attached to the rotating shaft.

Preferably, the at least one property of the system is a property of a fluid at least partially interacting with the rotating component and/or a property of the rotating component. For example, the property of the fluid may be a density, a viscosity and/or a flow type. Also, the property of the rotating component may be a bending and/or an unbalance and/or a misalignment and/or a radial displacement and/or an axial displacement of the rotating component of the rotating component. For example, if the rotating system is an agitator, it may be possible by determining a viscosity and/or a density of the fluid that is mixed with the agitator to monitor a reaction and/or mixing state. This may have the further advantage that it may be possible to reduce cycle time in tanks. In case the rotating system is an underwater impeller, it may be possible by determining a property of the rotating systems such as a bending and/or a displacement and/or an unbalance of the rotating shaft, to detect shallow water conditions and/or cavitation and/or to void an undesirable operating point for more efficient power transfer and/or a reduction or limitation of wear. For example, the life span of seals may be increased.

According to a further aspect, a fluid machinery is provided, comprising at least one bearing having a first ring, a second ring, and at least one row of rolling elements arranged between the first ring and the second ring, a rotating shaft supported by the bearing, wherein the rotating shaft comprises at least one element interacting with a fluid, at least one sensor probe arranged at a rotating component of the fluid machinery, wherein the at least one sensor probe is configured to measure a displacement and/or strain of the element, wherein the rotating component is one of the first bearing ring, the second bearing ring, a rolling element and/or the rotating shaft, and a device for estimating at least one property of a system as mentioned above.

According to another aspect, a method for estimating at least one property of a rotating system is provided, wherein the rotating system comprises at least one bearing configured to support at least one rotating component, wherein the method comprises:
a. equipping an element of the rotating system with at least one sensor probe, wherein the at least one sensor probe is configured to measure a displacement and/or strain of the element,
b. measuring a sensor signal waveform using the at least one sensor probe,
c. processing the measured sensor signal waveform, wherein the processing comprises
d. determining a spectrum of a load acting on the at least on rotating component from the measured sensor signal waveform, and
estimating the at least one property of the rotating system from the determined spectrum.

An even further aspect of the present disclosure relates to a computer program product comprising a computer program code which is adapted to prompt a control unit, e.g. a computer, and/or a computer of the above discussed manufacturing arrangement to perform the above discussed steps.

The computer program product may be a provided as memory device, such as a memory card, USB stick, CD-ROM, DVD and/or may be a file which may be downloaded from a server, particularly a remote server, in a network. The network may be a wireless communication network for transferring the file with the computer program product.

Further preferred embodiments are defined in the dependent claims as well as in the description and the figures. Thereby, elements described or shown in combination with other elements may be present alone or in combination with other elements without departing from the scope of protection.

### BRIEF DESCRIPTION OF THE DRAWINGS

In the following, preferred embodiments of the present disclosure are described in relation to the drawings, wherein the drawings are exemplarily only, and are not intended to limit the scope of protection. The scope of protection is defined by the accompanied claims, only. The figures show:

FIG. 1: a schematic illustration of a rotating system with a device for estimating at least one property of a rotating system according to an embodiment,

FIG. 2: a graph illustrating load spectrum of a load transferred from a fluid to the rotating system, and

FIG. 3: a flow chart illustrating a method for estimating at least one property of a rotating system according to an embodiment.

### DETAILED DESCRIPTION

In the following same or similar functioning elements are indicated with the same reference numerals.

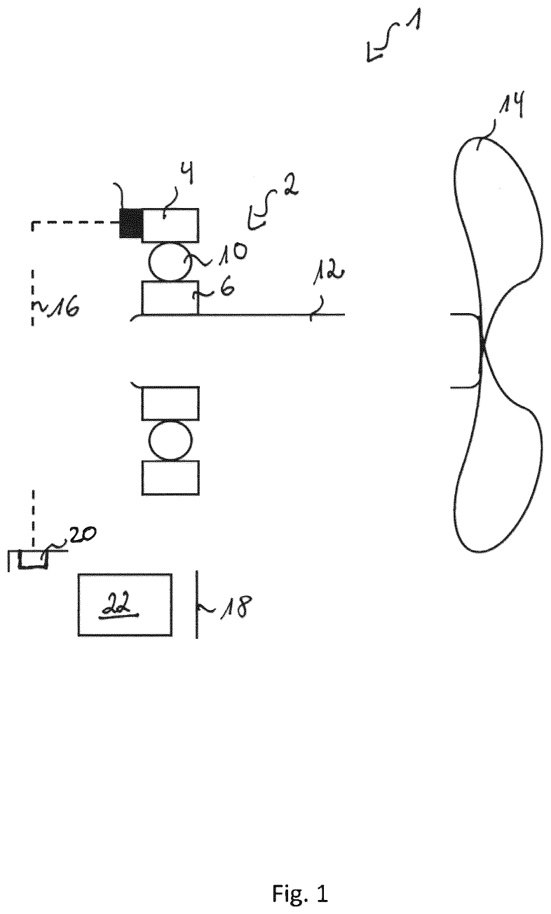

FIG. 1 shows a rotating system 1 which comprises bearing 2 having a first ring 4 equipped with at least one sensor probe 8, a second ring 6, and a row of rolling elements 10 arranged between the first ring 4 and the second ring 6. The bearing 2 supports a rotating shaft 12 which comprises two blades 14 that interact with a fluid. For example, the rotating system may be a wind turbine, a marine turbine, an underwater screw, an agitator or the like. The fluid may be water, air, oil, grease, or another liquid and/or gaseous medium.

The sensor probe 8 is configured to measure a displacement and/or deformation of the first ring 4 related to a local rolling element force acting on the bearing. For example, the sensor probe 8 may be a strain gauge, a fiber optic-based strain gauge, a piezo-resistive sensing element, an eddy current sensor or any other sensor gauge capable of sensing a displacement and/or deformation of the bearing. Also, the rotating system 1 may be equipped with more than one sensor probe 8. For example, another sensor probe 8 may be arranged at the rotating shaft 12.

The sensor probe 8 is connected to a transmitting unit 16 configured to transmit the sensor signal which is measured by the sensor probe 8 to a device 18 for estimating at least one property of the rotating system 1. In particular, the measured sensor signal may be transmitted to the device 18 via at least one cable and/or wireless.

The device 18 comprises a receiving unit 20 for receiving the sensor signal waveform measured by the sensor probe 8 and an electronic control unit 22 configured to process the received measured sensor signal waveform. More particularly, the receiving unit 20, and the electronic unit 22 may be integral and/or may be separate units. The signal measured by the sensor probe 8 is a time dependent strain signal waveform which is a product of a carrier waveform and a load waveform, and can be represented in the time domain as follows:

$$e ( t ) = F ( t ) \cdot c ( t )$$

wherein e(t) is the measured strain waveform, F(t) is the load waveform, and c(t) is the carrier waveform.

The electronic control unit 22 is configured to determine a rotation frequency fᵣₑ of the rotating component from the measured strain signal waveform by transforming the measured strain signal waveform into the frequency domain, preferably by using a fast Fourier transformation, and to determine based on the determined rotation frequency and the measured strain signal waveform, the carrier waveform c(t) in the frequency domain. In the example shown in FIG. 1, the rotation frequency is a rolling element frequency. However, if the sensor probe 8 is arranged at the rotating shaft 12, the rotation frequency would be the frequency with which the rotating shaft 12 rotates. To determine the carrier waveform, the electronic control unit 22 is configured to parameterize the carrier waveform up to a predetermined harmonic of the rotation frequency fᵣₑ in the frequency domain, wherein preferably each harmonic is parameterized by a phase and an amplitude. For example, when considering three harmonics of the carrier waveform in the time domain, the carrier waveform can be expressed as follows:

$$c ( t ) = a 1 sin ( 2 π {f}_{re} + b 1 ) + a 2 sin ( 2 \cdot 2 π {f}_{re} + b 2 ) + a 3 sin ( 4 \cdot 2 π {f}_{re} + b 3 )$$

wherein the carrier waveform c(t) is parameterized by two parameters, namely the amplitude a1, a2, a3 and the phase b1, b2, b3, for each harmonic of the rolling element frequency fᵣₑ.

Furthermore, the electronic control unit 22 is also configured to determine the load waveform based on the determined and parameterized carrier waveform and the measured strain signal by parameterizing the load waveform using a predetermined number of parameters in the frequency domain. More particularly, the load wave form is parameterized for a plurality of frequencies by a phase and an amplitude corresponding to each frequency. The determination of the carrier waveform and the load waveform can be performed sequentially or simultaneously. For example, for each frequency of interest, two parameters, namely amplitude and phase, may be used. Alternatively or additionally, the control electronic control unit 22 is configured to determine the spectrum of the measured strain signal waveform directly.

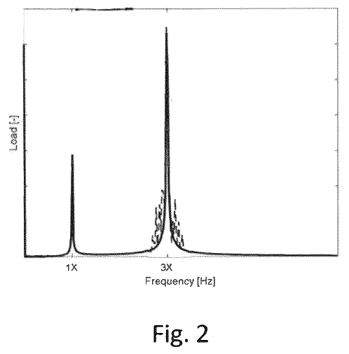

FIG. 2 shows a graph illustrating load spectrum of a load transferred from a fluid to a rotating system 1, wherein the x-axis represents the time, and the y-axis represents the load. The load spectrum in FIG. 2 is associated with rotating system 1 that has a rotating shaft 12 with three attached blades 14. Due these three blades 14, load spectrum does not only show a peak at the rotation frequency of the rotating system 1× but also at 3×. The solid line is a load spectrum of a load transferred from a fluid having no turbulences to the rotating system 1, while the dashed line is a load spectrum of a load transferred from a fluid with turbulences to the rotating system 1. As can be seen from FIG. 2, the turbulences can broaden the energy at frequencies around 3× (3 times shaft frequency).

These changes to the load spectrum caused by the interaction between the fluid and the blades 14 can be analyzed by electronic control unit 22 and a quantification of this changes can act as input for a control unit controlling the rotating system 1. In particular, a control signal may be a signal that controls a drive frequency with which the rotating system 1 is driven. For example, the control signal may be used to stay or move away from the measured working point to reach a higher efficiency or prolonged lifetime. In order to obtain such a control signal, the electronic control unit 22 may be configured to determine a position and/or a magnitude of at least one peak in the determined load spectrum, to determine a peak width, e.g. a FWHM (full width at half maximum)-width.

In addition, the electronic control unit 22 may be configured to compare the determined spectrum to a reference spectrum, which may be a predetermined reference spectrum and/or a theoretical reference spectrum. Moreover, the electronic control unit may be further configured to determine an absolute magnitude of at least one peak, to determine a relative amplitude between a first peak and a second peak, to determine a peak width, to compare the absolute magnitude of at least one peak to a predefined threshold, and/or compare the determined relative magnitude between at least two peaks to a predefined threshold. The reference spectrum and/or the predefined threshold may be stored in a storage unit in the electronic control unit 22.

Advantageously, it may also be possible to determine a property of the fluid and/or a property of the rotating component from the determined spectrum. For example, the property of the fluid may be a density, a viscosity and/or a flow type. The property of the rotating component may be a bending of the rotating component. For example, if the rotating system is an agitator, it may be possible by determining a viscosity and/or a density of the fluid that is mixed with the agitator to monitor a reaction and/or mixing state. This may have the further advantage that it may be possible to reduce cycle time in tanks. In case the rotating system is an underwater impeller or a wind turbine, it may be possible by determining a property of the rotating systems such as a bending of the rotating shaft, to void an undesirable operating point for more efficient power transfer and/or a reduction or limitation of wear. For example, the life span of seals may be increased.

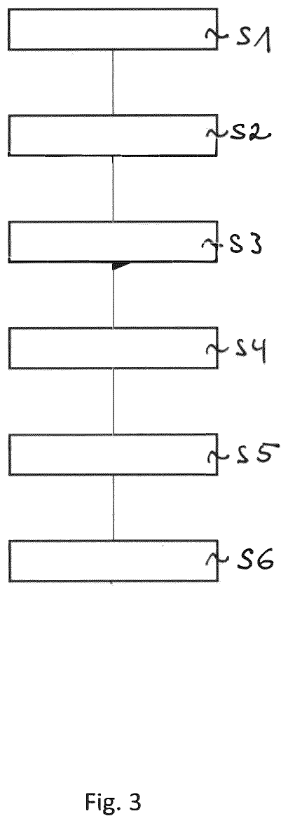

FIG. 3 shows a flow chart which schematically illustrates a method for estimating at least one property of a rotating system 1 comprising at least one bearing 2 configured to support at least one rotating component 12. The method comprises as a first step S1 equipping an element of the rotating system 1 with at least one sensor probe 8, wherein the at least one sensor probe is configured to measure a displacement and/or strain of the element. In a second step S2 a sensor signal waveform is measured using the at least one sensor probe 8.

After measuring the sensor signal waveform, the measured sensor signal waveform is transmitted in a third step S3 from the at least one sensor probe 8 to the electronic control unit 22 which processes in a fourth step S4 the measured sensor signal waveform. The processing comprises as a fifth step S5 determining a spectrum of the lead acting on the rotating component from the measured sensor signal waveform, and as a sixth step S6 estimating the at least one property of the rotating system from the determined spectrum. For example, the spectrum may be strain spectrum that is determined directly from the measured strain waveform. Alternatively, a load waveform may be determined from the measured strain and/or displacement signal and the spectrum may be determined from the load waveform.

In summary, the described device and method for estimating at least one property of the rotating system allows to determine these properties more direct and/or less sensitive to noise factors. By determining qualitative and/or quantitative information from the spectrum, such as an amplitude of a peak in the spectrum, a position of a peak, i.e. a frequency of the load, and/or frequency combinations of load, properties of the rotating system 1 and/or the fluid interacting with the rotating system 1 can be determined. The information can be used to determine a working point of the rotating system 1 and to generate a respective control signal to keep the rotating system 1 at the working point or to move rotating system 1 to a more favorable working point in order to increase efficiency and/or reduce wear.

### REFERENCE NUMERALS

1 rotating system
2 bearing
4 first ring
6 second ring
8 sensor probe
10 rolling element
12 rotating shaft
14 blade
16 transmitting unit
18 device
20 receiving unit
22 electronic control unit
S1 to S6 method steps

What is claimed is:

1. A device for estimating at least one property of a rotating system, the rotating system having at least one rotating component, the device comprising:
at least one sensor probe arranged at the at least one rotating component, the at least one sensor probe being configured to measure a displacement and/or strain of the at least one rotating component,
a receiving unit for receiving a sensor signal waveform provided by the at least one sensor probe, and
an electronic control unit configured for processing the received measured sensor signal waveform, the electronic control unit being configured to:
determine a spectrum of the load acting on the at least one rotating component from the measured sensor signal waveform, and
estimate the at least one property of the rotating system from the determined spectrum.

2. The device according to claim 1, wherein the sensor signal waveform is provided in the time domain, and wherein determining the spectrum of the load includes transforming the measured sensor signal waveform from the time domain into the frequency domain, preferably by using a fast Fourier transformation.

3. The device according to claim 1, wherein the electronic control unit is further configured to analyze the determined spectrum, wherein analyzing the determined spectrum includes determining a position and/or a magnitude of at least one peak in the determined spectrum and/or a phase characteristic of the load and/or strain.

4. The device according to claim 1, wherein the electronic control unit is further configured for determining a control signal for controlling the system based on the determined spectrum.

5. The device according to claim 4, wherein determining the control signal comprises comparing the determined spectrum to a reference spectrum and/or determining an absolute magnitude of at least one peak and/or determining a relative amplitude between a first peak and a second peak and/or determining a peak width and/or determining a phase characteristic of the load and/or strain and/or comparing the absolute magnitude of at least one peak to a predefined threshold and/or comparing the determined relative magnitude between at least two peaks to a predefined threshold.

6. The device according to claim 1, wherein the rotating system is a fluid machinery having a rotating shaft with at least one element configured to interact with a fluid, wherein the rotating shaft is supported by a bearing, and wherein the at least one sensor probe is arranged at the bearing and/or the rotating shaft.

7. The device according to claim 6, wherein the at least one property of the system is a property of a fluid at least partially interacting with the rotating component and/or a property of the rotating component.

8. The device according to claim 7, wherein the property of the fluid is a density, a viscosity and/or a flow type, and wherein the property of the rotating component is a bending and/or an unbalance and/or a misalignment and/or a radial displacement and/or an axial displacement of the rotating component of the rotating component.

9. Fluid machinery comprising:
at least one bearing having a first ring, a second ring, and at least one row of rolling elements arranged between the first ring and the second ring,
a rotating shaft supported by the bearing, wherein the rotating shaft comprises at least one element interacting with a fluid,
at least one sensor probe arranged at a rotating component of the fluid machinery, wherein the at least one sensor probe is configured to measure a displacement and/or strain of the element, wherein the rotating component is one of the first bearing ring, the second bearing ring, a rolling element and/or the rotating shaft, and
the device for estimating at least one property of a rotating system according to claim 1.

10. The device according to claim 2, wherein the electronic control unit is further configured to analyze the determined spectrum, wherein analyzing the determined spectrum includes determining a position and/or a magnitude of at least one peak in the determined spectrum and/or a phase characteristic of the load and/or strain.

11. The device according to claim 10, wherein the electronic control unit is further configured for determining a control signal for controlling the system based on the determined spectrum.

12. The device according to claim 11, wherein determining the control signal comprises comparing the determined spectrum to a reference spectrum and/or determining an absolute magnitude of at least one peak and/or determining a relative amplitude between a first peak and a second peak and/or determining a peak width and/or determining a phase characteristic of the load and/or strain and/or comparing the absolute magnitude of at least one peak to a predefined threshold and/or comparing the determined relative magnitude between at least two peaks to a predefined threshold.

13. The device according to claim 12, wherein the rotating system is a fluid machinery having a rotating shaft with at least one element configured to interact with a fluid, wherein the rotating shaft is supported by a bearing, and wherein the at least one sensor probe is arranged at the bearing and/or the rotating shaft.

14. The device according to claim 13, wherein the at least one property of the system is a property of a fluid at least partially interacting with the rotating component and/or a property of the rotating component.

15. The device according to claim 14, wherein the property of the fluid is a density, a viscosity and/or a flow type, and wherein the property of the rotating component is a bending and/or an unbalance and/or a misalignment and/or a radial displacement and/or an axial displacement of the rotating component of the rotating component.

16. Fluid machinery comprising:
at least one bearing having a first ring, a second ring, and at least one row of rolling elements arranged between the first ring and the second ring,
a rotating shaft supported by the bearing, wherein the rotating shaft comprises at least one element interacting with a fluid,
at least one sensor probe arranged at a rotating component of the fluid machinery, wherein the at least one sensor probe is configured to measure a displacement and/or strain of the element, wherein the rotating component is one of the first bearing ring, the second bearing ring, a rolling element and/or the rotating shaft, and
the device for estimating at least one property of a rotating system according to claim 15.

17. A method for estimating at least one property of a rotating system, the rotating system comprising at least one rotating component, the method comprising:
equipping the at least one rotating component with at least one sensor probe, the at least one sensor probe being configured to measure a displacement and/or strain of the at least one rotating component,
measuring a sensor signal waveform using the at least one sensor probe,
processing the measured sensor signal waveform,
wherein the processing comprises:
determining a spectrum of the load acting on the at least one rotating component from the measured sensor signal waveform, and
estimating the at least one property of the rotating system from the determined spectrum.
